(19) United States
(12) Patent Application Publication
(10) Pub. No.: US 2024/0427989 A1
(43) Pub. Date: Dec. 26, 2024

(54) INFORMATION PROCESSING APPARATUS, INFORMATION PROCESSING METHOD, AND STORAGE MEDIUM

(71) Applicant: NEC Corporation, Tokyo (JP)

(72) Inventors: Daichi HISADA, Tokyo (JP); Naotake FUJITA, Tokyo (JP)

(73) Assignee: NEC Corporation, Tokyo (JP)

(21) Appl. No.: 18/744,796

(22) Filed: Jun. 17, 2024

(30) Foreign Application Priority Data
Jun. 20, 2023 (JP) 2023-100955

(51) Int. Cl. G06F 40/279; G06F 16/332

(52) U.S. Cl. CPC G06F 40/279; G06F 16/3329

(57) ABSTRACT

Provided is a work assistance technique which is applicable to various kinds of work. An information processing apparatus includes: an identification means for identifying a work category of a target; a generation means for generating a prompt that corresponds to the work category which has been identified by the identification means; and an acquisition means for acquiring a generation sentence which has been generated based on the prompt.

This Nonprovisional application claims priority under 35 U.S.C. § 119 on Patent Application No. 2023-100955 filed in Japan on Jun. 20, 2023, the entire contents of which are hereby incorporated by reference.

### TECHNICAL FIELD

The present invention relates to an information processing apparatus, an information processing method, and a storage medium.

### BACKGROUND ART

Techniques to assist various kinds of tasks such as preparation and checking of documents are being developed. For example, Patent Literature 1 discloses a document preparation program and an information processing apparatus which generate a legal document based on tasks by a plurality of persons.

### CITATION LIST

### Patent Literature

### Patent Literature 1

Japanese Patent Application Publication Tokukai No. 2020-166870

### SUMMARY OF INVENTION

### Technical Problem

Generally, tasks such as preparation and checking of documents can be carried out in various kinds of work. However, the technique disclosed in Patent Literature 1 has a problem in terms of applicability to various kinds of work.

The present disclosure is accomplished in view of the above problem, and an example object thereof is to provide a work assistance technique which is applicable to various kinds of work.

### Solution to Problem

An information processing apparatus in accordance with an example aspect of the present disclosure includes at least one processor, the at least one processor carrying out: an identification process of identifying a work category of a target; a generation process of generating a prompt that corresponds to the work category which has been identified in the identification process; and an acquisition process of acquiring a generation sentence which has been generated based on the prompt.

An information processing method in accordance with an example aspect of the present disclosure includes: identifying, by at least one processor, a work category corresponding to a target sentence; generating, by the at least one processor, a prompt corresponding to the work category which has been identified in the identifying; and acquiring, by the at least one processor, a generation sentence which has been generated based on the prompt.

A non-transitory storage medium in accordance with an example aspect of the present disclosure stores a program which causes a computer to carry out: an identification process of identifying a work category corresponding to a target sentence; a generation process of generating a prompt that corresponds to the work category which has been identified in the identification process; and an acquisition process of acquiring a generation sentence which has been generated based on the prompt.

### Advantageous Effects of Invention

According to the present disclosure, it is possible to provide a work assistance technique which is applicable to various kinds of work.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an information processing method in accordance with the present disclosure.

FIG. 3 is a block diagram illustrating a configuration of an information processing system in accordance with the present disclosure.

FIG. 4 is a flowchart illustrating a flow of an element extraction process in accordance with the present disclosure.

FIG. 5 is a diagram for describing an element extraction process in accordance with the present disclosure.

FIG. 6 is a flowchart illustrating a flow of a prompt generation and generation sentence acquisition process in accordance with the present disclosure.

FIG. 7 is a diagram for describing a prompt generation and generation sentence acquisition process in accordance with the present disclosure.

FIG. 8 is a diagram for describing a prompt generation and generation sentence acquisition process in accordance with the present disclosure.

FIG. 9 is a diagram for describing a prompt generation and generation sentence acquisition process in accordance with the present disclosure.

FIG. 10 is a diagram for describing a prompt generation and generation sentence acquisition process in accordance with the present disclosure.

FIG. 11 is a diagram for describing a prompt generation and generation sentence acquisition process in accordance with the present disclosure.

FIG. 12 is a diagram for describing a prompt generation and generation sentence acquisition process in accordance with the present disclosure.

FIG. 13 is a block diagram illustrating a hardware configuration of an information processing apparatus in accordance with the present disclosure.

### EXAMPLE EMBODIMENTS

The following description will discuss an example embodiment of the present invention. Note, however, that the present invention is not limited to example embodiments described below, but may be altered in various ways by a skilled person within the scope of the claims. For example, the present invention can also encompass, in its scope, any example embodiment derived by appropriately combining technical means employed in the example embodiments described below. Alternatively, the present invention also encompasses, in its scope, any example embodiment derived by appropriately omitting part of technical means employed in the example embodiments described below. The example advantages described in each of the example embodiments below are example advantages expected in that example embodiment, and do not define an extension of the present invention. That is, the present invention also encompasses, in its scope, any example embodiment that does not bring about the example advantages described in the example embodiments below.

### First Example Embodiment

The following description will discuss a first example embodiment, which is an example of an embodiment of the present invention, in detail, with reference to the drawings. The present example embodiment is a basic form of example embodiments described later. Note that an application scope of technical means which are employed in the present example embodiment is not limited to the present example embodiment. That is, technical means employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Information Processing Apparatus 1)

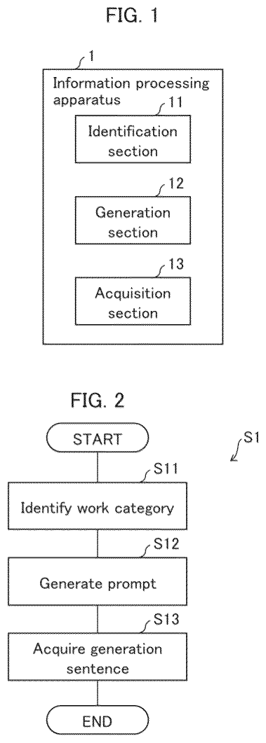

The following description will discuss a configuration of an information processing apparatus 1 in accordance with the present example embodiment, with reference to FIG. 1. FIG. 1 is a block diagram illustrating a configuration of the information processing apparatus 1. As illustrated in FIG. 1, the information processing apparatus 1 includes an identification section 11, a generation section 12, and an acquisition section 13.

### (Identification Section 11)

The identification section 11 identifies a work category of a target, and provides, to the generation section 12 (described later), category information indicating the identified work category. For example, the identification section 11 acquires an instruction from a user, and identifies a work category of a target with reference to wording included in the instruction. Alternatively, it is possible to employ a configuration in which the identification section 11 acquires information indicating selection by a user in regard to a work category, and identifies a work category of a target with reference to the information.

Here, the term “work category” in the present example embodiment is intended to mean a category pertaining to at least one of, for example, industries and types of occupation (duties). For example, the work category can include categories corresponding respectively to the following plurality of industries:
publishing industry;
financial industry;
other general industries; and the like.
   Each of the categories can include, for example, subcategories which correspond respectively to the following plurality of types of occupation (duties):
mail preparation;
title proposal;
needs survey;
preparation of an estimate;
preparation of a contract;
legal check of a contract; and the like.
   Here, a certain subcategory may exist over a plurality of categories. For example, the subcategory “mail preparation” can exist in all categories of the publishing industry, the financial industry, and other general industries. In the present example embodiment, the wording “work category” can include the foregoing “industry category” and “type-of-occupation subcategory”. Note, however, that this does not limit the present example embodiment.

### (Generation Section 12)

The generation section 12 generates a prompt corresponding to the work category which has been identified by the identification section 11. Here, the prompt generated by the generation section 12 is a prompt to be input into a language model (described later), and the language model generates a generation sentence (described later) with reference to content of the prompt. A specific configuration of the prompt generated by the generation section 12 does not limit the present example embodiment. For example, it is possible to employ a configuration in which the generation section 12 carries out an extraction process of extracting, from one or more target sentences, one or more elements corresponding to the work category which has been identified by the identification section 11, and the generation section 12 generates the prompt corresponding to the one or more elements which have been extracted in the extraction process. Alternatively, it is possible to employ a configuration in which the generation section 12 generates the prompt which includes (i) an instruction sentence corresponding to an instruction from a user and (ii) one or more elements which have been extracted in the extraction process. The prompt generated by the generation section 12 is a prompt including a natural sentence. Note, however, that the present example embodiment is not limited thereto.

### (Acquisition Section 13)

The acquisition section 13 acquires a generation sentence which has been generated based on the prompt generated by the generation section 12. More specifically, the acquisition section 13 acquires a sentence (hereinafter simply referred to also as “generation sentence”) which has been generated by a language model upon receipt of input of the prompt generated by the generation section 12. Here, the language model may be a language model that is executed inside the information processing apparatus 1 or may be a language model that is executed by a generation apparatus which is communicably connected to the information processing apparatus 1. The language model is, for example, a language model which generates a generation sentence as a natural sentence with reference to a prompt including a natural sentence, and which has been subjected to machine learning in advance. Note, however, that the present example embodiment is not limited thereto.

### (Example Advantage of Information Processing Apparatus 1)

As described above, the information processing apparatus 1 employs the configuration of: identifying a work category of a target; generating a prompt corresponding to the identified work category; and acquiring a generation sentence generated based on the prompt. Therefore, according to the information processing apparatus 1, it is possible to provide a work assistance technique which is applicable to various kinds of work.

### (Flow of Information Processing Method S1)

The following description will discuss a flow of an information processing method S1 in accordance with the present example embodiment, with reference to FIG. 2. FIG. 2 is a flowchart illustrating the flow of the information processing method S1. As illustrated in FIG. 2, the information processing method S1 includes step (process) S11 of identifying a work category, step (process) S12 of generating a prompt, and step (process) S13 of acquiring a generation sentence.

### (Step S11)

In step S11, the identification section 11 identifies a work category of a target, and provides, to the generation section 12 (described later), category information indicating the identified work category. The specific description pertaining to the identification section 11 is described above, and is therefore omitted here.

### (Step S12)

In step S12, the generation section 12 generates a prompt corresponding to the work category which has been identified by the identification section 11 in step S11. The specific process pertaining to the generation section 12 is described above, and therefore a description thereof is omitted here.

### (Step S13)

In step S13, the acquisition section 13 acquires a generation sentence which has been generated based on the prompt generated by the generation section 12 in step S12. The specific description pertaining to the acquisition section 13 is described above, and is therefore omitted here.

### (Example Advantage of Information Processing Method S1)

As described above, the information processing method S1 employs the configuration of: identifying a work category of a target; generating a prompt corresponding to the identified work category; and acquiring a generation sentence generated based on the prompt. Therefore, according to the information processing method S1, it is possible to provide a work assistance technique which is applicable to various kinds of work.

### Second Example Embodiment

The following description will discuss a second example embodiment, which is an example of an embodiment of the present invention, in detail, with reference to the drawings. The same reference numerals are given to constituent elements having the same functions as those described in the foregoing example embodiment, and descriptions of such constituent elements are omitted as appropriate. Note that an application scope of technical means which are employed in the present example embodiment is not limited to the present example embodiment. That is, technical means employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Information Processing System 1A)

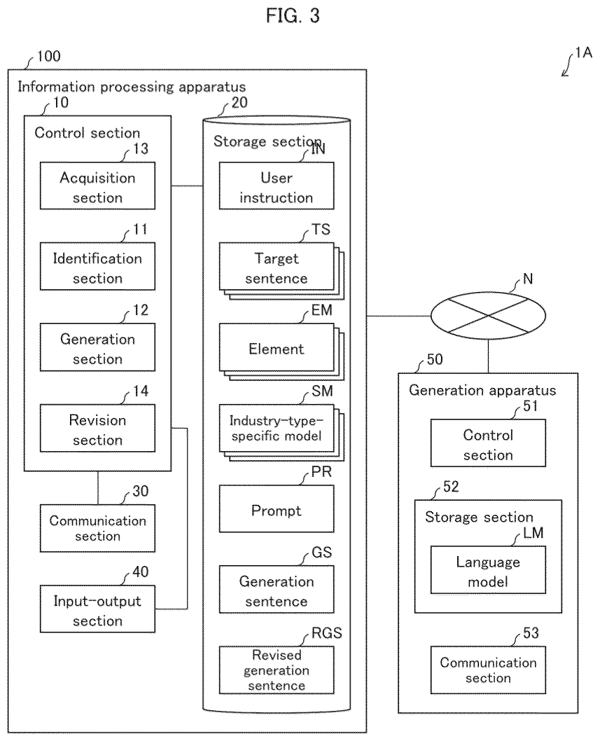

The following description will discuss a configuration of an information processing system 1A in accordance with the present example embodiment, with reference to FIG. 3. FIG. 3 is a block diagram illustrating the configuration of the information processing system 1A. As illustrated in FIG. 3, the information processing system 1A includes an information processing apparatus 100 and a generation apparatus 50 that is connected to the information processing apparatus 100 via a network N. A specific configuration of the network N does not limit the present example embodiment, and the network N is, for example, a wireless local area network (LAN), a wired LAN, a wide area network (WAN), a public network, a mobile data communication network, or a combination of these networks.

### (Generation Apparatus 50)

As illustrated in FIG. 3, the generation apparatus 50 includes a control section 51, a storage section 52, and a communication section 53. The communication section 53 communicates with an apparatus external to the generation apparatus 50. For example, the communication section 53 communicates with the information processing apparatus 100 included in the information processing system 1A. The communication section 53 transmits data supplied from the control section 51 to the information processing apparatus 100 or supplies data received from the information processing apparatus 100 to the control section 51. Note that data received by the communication section 53 from the information processing apparatus 100 can include a prompt generated by the information processing apparatus 100. Data provided by the communication section 53 to the information processing apparatus 100 can include a generation sentence which has been generated by a language model (described later) based on the prompt.

The storage section 52 stores a language model LM. For example, the storage section 52 stores a plurality of parameters that define the language model LM. These parameters are, for example, parameters which have been trained in advance by machine learning (i.e., parameters which have undergone an updating process by machine learning). Note, however, that the present example embodiment is not limited thereto.

The control section 51 executes the language model and thus acquires an output result by the language model LM. For example, the control section 51 inputs, into the language model LM, a prompt received from the information processing apparatus 100, and acquires a generation sentence generated by the language model LM. Moreover, the control section 51 provides the generation sentence to the information processing apparatus 100 via the communication section 53.

In the present example embodiment, the generation apparatus 50 is exemplified as an apparatus separated from the information processing apparatus 100. Note, however, that the present example embodiment is not limited thereto. It is possible to employ a configuration in which control section of the information processing apparatus 100 has the function as the control section 51 included in the generation apparatus 50 or as a language model execution section in the control section 51. Similarly, it is possible to employ a configuration in which a storage section of the information processing apparatus 100 stores the language model LM stored in the storage section 52 included in the generation apparatus 50, and the language model LM can be executed by the information processing apparatus 100 itself.

### (Configuration of Information Processing Apparatus 100)

The following description will discuss a configuration of an information processing apparatus 100 in accordance with the present example embodiment, with reference to FIG. 3. As illustrated in FIG. 3, the information processing apparatus 100 includes a control section 10, a storage section 20, a communication section 30, and an input-output section 40.

### (Communication Section 30)

The communication section 30 communicates with an apparatus external to the information processing apparatus 100. For example, the communication section 30 communicates with the generation apparatus 50. The communication section 30 transmits data supplied from the control section 10 to the generation apparatus 50 or supplies data received from the generation apparatus 50 to the control section 10. Note that data transmitted by the communication section 30 to the generation apparatus 50 can include a prompt generated by the control section 10. Data received by the communication section 30 from the generation apparatus 50 can include a generation sentence generated by the generation apparatus 50 based on the prompt.

### (Input-Output Section 40)

The input-output section 40 is configured to include at least one of input-output apparatuses such as a keyboard, a mouse, a display, a printer, a touch panel, and the like. Alternatively, it is possible to employ a configuration in which input-output apparatuses such as a keyboard, a mouse, a display, a printer, and a touch panel are connected to the input-output section 40. In the case of such a configuration, the input-output section 40 receives input of various kinds of information with respect to the information processing apparatus 100 from the connected input apparatus. Moreover, the input-output section 40 outputs various kinds of information to the connected output apparatus under control of the control section 10. Examples of the input-output section 40 include interfaces such as a universal serial bus (USB).

### (Storage Section 20)

The storage section 20 stores various kinds of data referred to by the control section 10 and various kinds of data generated by the control section 10. For example, the storage section 20 stores:
a user instruction IN acquired by the acquisition section 13 via the input-output section 40 or the communication section 30;
one or more target sentences TS;
one or more elements EM extracted from the target sentence(s) TS;
a plurality of industry-type-specific models SM;
a prompt PR generated by the control section 10;
a generation sentence GS generated by the generation apparatus 50; and
a revised generation sentence RGS.
   The specific descriptions pertaining to various kinds of data stored in the storage section 20 will be described later.

### (Control Section 10)

As illustrated in FIG. 3, the control section 10 includes an identification section 11, a generation section 12, and an acquisition section 13, as with the first example embodiment. The control section 10 includes a revision section 14 in addition to these constituent elements.

### (Acquisition Section 13)

The acquisition section 13 acquires a user instruction IN via the input-output section 40 or the communication section 30, and causes the storage section 20 to store the acquired user instruction IN. The user instruction IN can include, for example, wording which suggests:
what kind of process is requested to be carried out in which industry-type category.
   The user instruction acquired by the acquisition section 13 is referred to by the identification section 11 and the generation section 12 (described later).

The acquisition section 13 acquires, based on a prompt PR generated by the generation section 12, a generation sentence GS generated by the generation apparatus 50, and causes the storage section 20 to store the generation sentence GS.

### (Identification Section 11)

As described in the first example embodiment, the identification section 11 identifies a work category of a target and provides, to the generation section 12 (described later), category information indicating the identified work category. For example, the identification section 11 identifies a work category of a target with reference to wording included in the user instruction IN acquired by the acquisition section 13. Alternatively, it is possible to employ a configuration in which the identification section 11 acquires information indicating selection by a user included in the user instruction IN, and identifies a work category of a target with reference to the information.

Here, as described in the first example embodiment, the term “work category” in the present example embodiment is intended to mean a category pertaining to at least one of, for example, industries and types of occupation (duties).

### (Generation Section 12)

The generation section 12 generates a prompt PR corresponding to the work category which has been identified by the identification section 11 (prompt generation process). Here, the prompt PR generated by the generation section 12 is a prompt to be input into a language model LM executed by the generation apparatus 50. A specific configuration of the prompt generated by the generation section 12 does not limit the present example embodiment. For example, it is possible to employ a configuration in which the generation section 12 carries out an extraction process (element extraction process) of extracting, from one or more target sentences TS, one or more elements EM corresponding to the work category which has been identified by the identification section 11, and the generation section 12 generates the prompt PR corresponding to the one or more elements EM which have been extracted in the extraction process.

Here, in the extraction process, the generation section 12 may use, for example, a language model (hereinafter referred to as “industry-type-specific model”) SM which has been trained for each work category.

Examples of the industry-type-specific model SM can include:
a first industry-type-specific model SM1 which has been trained by machine learning specific to a first industry type (first work category);
a second industry-type-specific model SM2 which has been trained by machine learning specific to a second industry type (second work category);
a third industry-type-specific model SM3 which has been trained by machine learning specific to a third industry type (third work category); and the like. More specifically, the industry-type-specific model SM can include:
a publishing industry mail-specific model SM1 which has been trained by training data including a plurality of pieces of mail in the publishing industry;
a financial industry contract-specific model SM2 which has been trained by training data including a plurality of contracts in the financial industry;
a general industry estimate-specific model SM3 which has been trained by training data including a plurality of estimates in other general industries; and the like. The generation section 12 can be configured to carry out the extraction process with use of an industry-type-specific model which has been trained specifically to a work category identified by the identification section 11. Note, however, that the present example embodiment is not limited to these examples.

It is possible to employ a configuration in which the generation section 12 generates a prompt PR which includes content corresponding to the user instruction IN. For example, it is possible to employ a configuration in which the generation section 12 generates the prompt PR which includes (i) an instruction sentence corresponding to the user instruction IN and (ii) an element EM which has been extracted in the extraction process.

The prompt PR generated by the generation section 12 is provided to the generation apparatus 50 via, for example, the communication section 30, and the generation apparatus 50 generates a generation sentence GS based on the prompt PR with use of the language model LM. The generated generation sentence GS is acquired by the acquisition section 13 described above via the communication section 30. Specific examples of the prompt PR generated by the generation section 12 and the generation sentence GS generated by the generation apparatus 50 will be described later.

### (Revision Section 14)

The revision section 14 revises the generation sentence GS which has been generated by the generation apparatus 50. More specifically, the revision section 14 revises the generation sentence GS in accordance with the work category identified by the identification section 11. For example, it is possible to employ a configuration in which the revision section 14 revises the generation sentence GS with use of the industry-type-specific model SM described above. For example, the revision section 14 may revise the generation sentence GS with use of an industry-type-specific model which has been trained specifically to a work category identified by the identification section 11. The revised generation sentence RGS is, for example, provided to a user via the input-output section 40 or the communication section 30.

### (Element Extraction Process Carried Out by Generation Section 12)

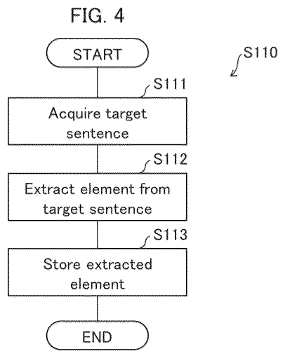

The following description will discuss a flow of an element extraction process carried out by the generation section 12, with reference to FIG. 4. The element extraction process is carried out, for example, prior to the prompt generation process carried out by the generation section 12. In other words, the element extraction process is carried out, for example, as preprocessing for the prompt generation process carried out by the generation section 12. Note, however, that the present example embodiment is not limited thereto. FIG. 4 is a flowchart illustrating the flow of the element extraction process carried out by the generation section 12.

### (Step S111)

In step S111, the acquisition section 13 acquires one or more target sentences. Here, it is possible to employ a configuration in which the acquisition section 13 acquires, as the one or more target sentences, sentences belonging to a specific work category. Alternatively, it is possible to employ a configuration in which the acquisition section 13 acquires, as the one or more target sentences, sentences pertaining to various work categories. Examples of target sentences to be acquired in this step include the following various documents or part of the documents:
mail sentences;
proposal sheets;
survey reports;
estimates;
contracts; and the like.
   It is possible to employ a configuration in which the acquisition section 13 acquires, as one or more target sentences, templates or part of templates of the above-described various kinds of documents.

### (Step S112)

In step S112, the generation section 12 extracts one or more elements from the one or more target sentences acquired in step S111. Here, an element may be any unit such as one phrase, a plurality of phrases, one clause, a plurality of clauses, one sentence, a plurality of sentences, one paragraph, a plurality of paragraphs, or the like. The generation section 12 may extract the element from the one or more target sentences with use of an industry-type-specific model which has been trained specifically to a work category to which the one or more target sentences belong. As described above, the industry-type-specific model is a model which has been trained specifically to each work category. Therefore, by using the industry-type-specific model, extraction of elements can be accurately carried out.

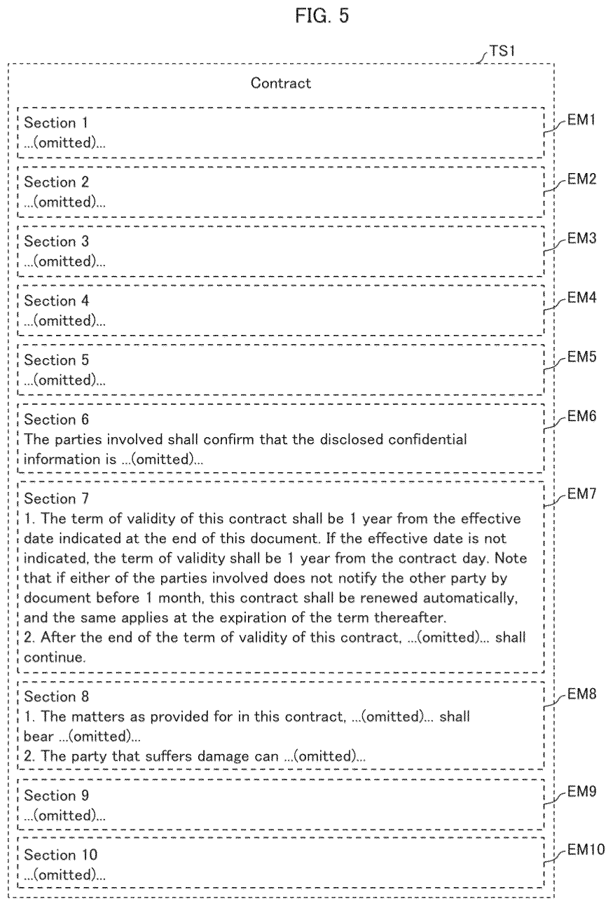

FIG. 5 is a diagram for describing a processing example of the generation section 12 in this step. In the example illustrated in FIG. 5, a contract is exemplified as a target sentence TS1, which is an example of the target sentence TS. The generation section 12 extracts, from the target sentence TS1, clauses included in the target sentence as respective elements EM1 through EM10.

### (Step S113)

In step S113, the generation section 12 causes the storage section 20 to store the elements which have been extracted in step S112. Here, the generation section 12, for example, stores the elements in association with a work category to which the target sentence from which the elements have been extracted belongs. In the example illustrated in FIG. 5, the generation section 12 stores the elements EM1 through EM10 in association with a work category “contract” or “work to generate or edit a contract” to which the target sentence from which the elements have been extracted belongs. Note, however, that the present example embodiment is not limited to these specific examples.

### Example 1 of Prompt Generation and Generation Sentence Output Process

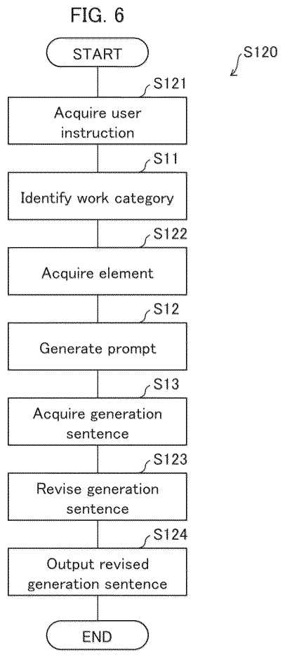

The following description will discuss example 1 of a prompt generation and generation sentence output process which is carried out by the information processing apparatus 100, with reference to FIG. 6. FIG. 6 is a flowchart illustrating a flow of example 1 of the prompt generation and generation sentence output process that is carried out by the information processing apparatus 100.

### (Step S121)

In step S121, the acquisition section 13 acquires a user instruction IN via the input-output section 40 or the communication section 30, and causes the storage section 20 to store the acquired user instruction IN. The user instruction IN can include, for example, wording which suggests:
what kind of process is requested to be carried out in which industry-type category.

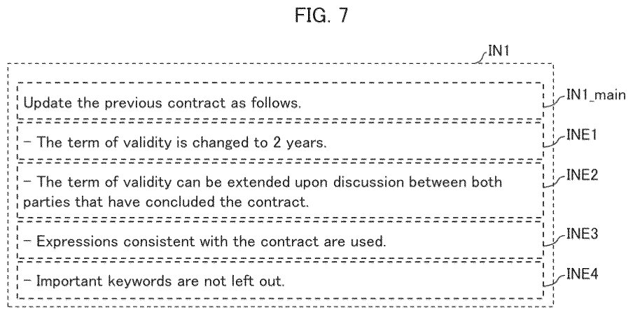

FIG. 7 is a diagram illustrating a user instruction IN1, which is an example of a user instruction acquired by the acquisition section 13 in this step. In the example illustrated in FIG. 7, the user instruction IN1 includes a user instruction main sentence IN1_main, and instruction elements INE1 through INE4 associated with the user instruction main sentence IN1_main.

### (Step S11)

In step S11, the identification section 11 identifies a work category of a target with reference to the user instruction IN acquired in step S121. For example, the identification section 11 identifies, with reference to one or more pieces of wording included in the user instruction IN1 illustrated in FIG. 7, a work category of the target as “contract” or “work to generate or edit a contract”.

The identification section 11 may, for example, carry out the category identification process using a language model included in the generation apparatus 50, or using any of the various industry-type-specific models described above, or using a combination of these models.

For example, the identification section 11 may carry out the following process of:
generating an industry-type-identifying prompt including the user instruction IN1 and an instruction sentence instructing identification of a work category of the user instruction IN1;
inputting the generated industry-type-identifying prompt into a language model included in the generation apparatus 50; and
identifying a work category of the target with reference to output of the language model.

As another example, the identification section 11 may carry out the following process of:
inputting the user instruction IN1 into a plurality of industry-type-specific models to identify a work category of a target with reference to output from each of the industry-type-specific models.
   As described above, the industry-type-specific model is a model which has been trained specifically to each work category. Therefore, by using the industry-type-specific model, a work category of the target can be accurately identified.

Alternatively, it is possible to employ a configuration in which the identification section 11 identifies a work category of a target with reference to a dictionary (keyword table) for each work category and depending on whether or not wording in the dictionary is included in the user instruction IN.

In the example illustrated in FIG. 7, the identification section 11, for example, identifies that the work category of the target is “work to generate or edit a contract” with reference to wording such as “contract” and “renew” included in the user instruction main sentence IN1_main and “term of validity” included in the instruction element INE1.

Note, however, that the work category identification process carried out by the identification section 11 is not limited to the above example. It is possible to employ a configuration in which the identification section 11 acquires information indicating selection by a user included in the user instruction IN, and identifies a work category of a target with reference to the information.

### (Step S122)

Subsequently, in step S122, the generation section 12 acquires one or more elements related to the work category which has been identified in step S11. For example, the generation section 12 acquires, out of elements which have been extracted in advance in the “element extraction process” described above, one or more elements related to the work category which has been identified in step S11.

In this example, in step S11, the identification section 11 identifies the work category of the target as “contract” or “work to generate or edit a contract”. Therefore, in step S122, the generation section 12 acquires, as the one or more elements, at least any of the elements EM1 through EM10 (see FIG. 5) associated with the work category.

### (Step S12)

Subsequently, in step S12, the generation section 12 refers to at least any of the following items and generates a prompt PR corresponding to the referred item(s):
the user instruction acquired in step S121;
the work category identified in step S11; and
the one or more elements acquired in step S122.

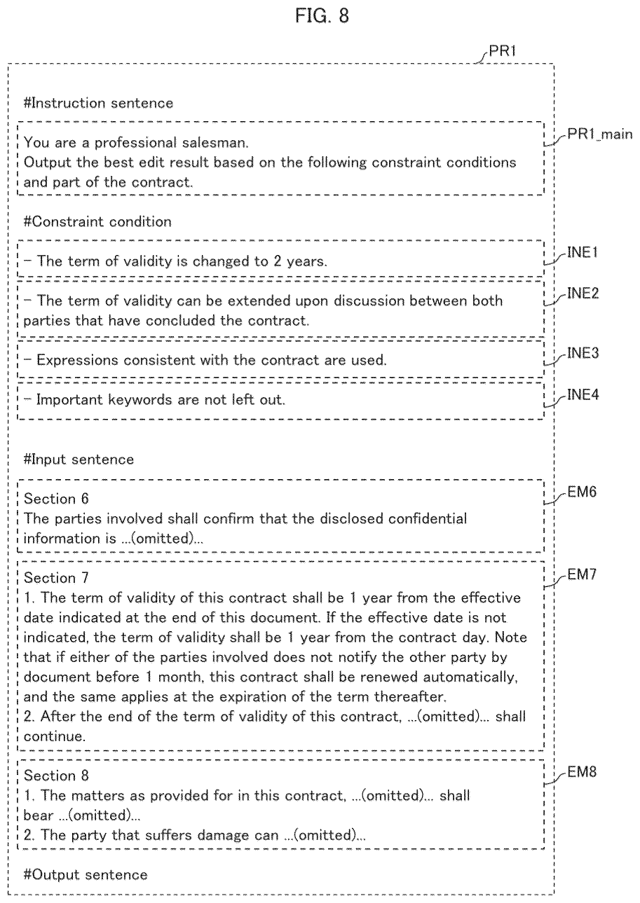

FIG. 8 is a diagram illustrating a prompt PR1 which is an example of a prompt generated by the generation section 12 in this step. As illustrated in FIG. 8, the prompt PR1 generated by the generation section 12 includes:
a tag indicating an instruction sentence (#instruction sentence);
content of an instruction sentence (PR1_main);
a tag indicating a constraint condition (#constraint condition);
content of a constraint condition (INE1 through INE4);
a tag indicating an input sentence (#input sentence);
content of an input sentence (EM6 through EM8); and
a tag indicating an output sentence (#output sentence). Here, the content of an instruction sentence (PR1_main) is content generated by the generation section 12 in accordance with the work category which has been identified by the identification section 11 in step S11. For example, the generation section 12 may generate the content of an instruction sentence (PR1_main) by carrying out the following process of:
managing a plurality of instruction sentences respectively associated with a plurality of work categories; and
selecting, from the plurality of instruction sentences, an instruction sentence associated with the work category which has been identified by the identification section 11.
   In the example illustrated in FIG. 8, the content of an instruction sentence (PR1_main) includes an instruction sentence “You are a professional salesman. Output the best edit result based on the following constraint conditions and part of the contract.” which corresponds to the work category “work to generate or edit a contract” of the target.

Meanwhile, the content of the constraint conditions (INE1 through INE4) is content generated by the generation section 12 based on information included in the user instruction IN acquired by the acquisition section 13 in step S121. In the example illustrated in FIG. 8, the generation section 12 uses, as content of constraint conditions, the instruction elements INE1 through INE4 included in the user instruction IN1 illustrated in FIG. 7. In other words, in the example illustrated in FIG. 8, the constraint conditions (INE1 through INE4) include the following conditions corresponding to the user instruction IN1:
the term of validity is changed to 2 years;
the term of validity can be extended upon discussion between both parties that have concluded the contract;
expressions consistent with the contract are used; and
important keywords are not left out.

The content of an input sentence (EM6 through EM8) includes one or more elements which have been acquired by the generation section 12 in step S122. In the example illustrated in FIG. 8, out of the elements EM1 through EM10 (see FIG. 5) associated with the work category “work to generate or edit a contract”, the elements EM6 through EM8 are included. In the example illustrated in FIG. 8, for example, the generation section 12 extracts, from the elements EM1 through EM10, the elements EM6 through EM8 which have a relatively high relevance with the user instruction IN1, and uses the elements EM6 through EM8 as content of an input sentence. Here, at least one of the language model LM and the industry-type-specific model described above may be used in the extraction process. Note, however, that these specific processes do not limit the present example embodiment, and it is possible to employ a configuration in which the generation section 12 uses all elements associated with a work category of a target as content of an input sentence.

As such, the prompt PR generated by the generation section 12 is, for example, a prompt which:
includes content corresponding to the user instruction IN; and
includes an instruction sentence corresponding to the user instruction IN and an element EM which has been extracted in the extraction process that has been carried out in advance in step S112.

In this step, the generation section 12 may generate the prompt PR by applying the following items to a predetermined prompt template:
content of an instruction sentence (PR1_main);
content of a constraint condition (INE1 through INE4); and
content of an input sentence (EM6 through EM8).
   For example, the generation section 12 may generate the prompt PR by applying the content of an instruction sentence (PR1_main), the content of a constraint condition (INE1 through INE4), and the content of an input sentence (EM6 through EM8) described above to a prompt template including:
a tag indicating an instruction sentence (#instruction sentence);
a tag indicating a constraint condition (#constraint condition); and
a tag indicating an input sentence (#input sentence).

As another example, the generation section 12 may generate the prompt PR by applying the content of a constraint condition (INE1 through INE4), and the content of an input sentence (EM6 through EM8) described above to a prompt template including:
a tag indicating an instruction sentence (#instruction sentence);
a tag indicating a constraint condition (#constraint condition); and
a tag indicating an input sentence (#input sentence); and also
content of an instruction sentence (PR1_main).

The prompt PR generated in this step is provided to the generation apparatus 50 via, for example, the communication section 30. Then, in the generation apparatus 50, the prompt is input into the language model LM, and the language model LM generates a generation sentence based on the prompt.

The control section 10 may be or may not be configured to present the generated prompt PR to a user via the input-output section 40.

### (Step S13)

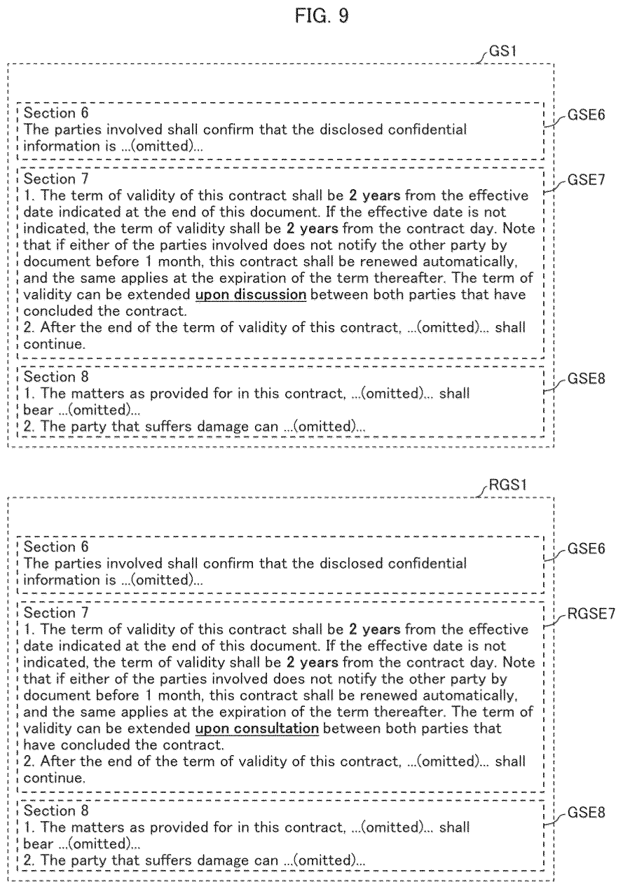

Subsequently, in step S13, the acquisition section 13 acquires the generation sentence GS which has been generated by the language model LM based on the prompt PR generated in step S12. The upper part of FIG. 9 illustrates a generation sentence GS1, which is an example of the generation sentence GS acquired by the acquisition section 13 in this step. In the example of the upper part of FIG. 9, bold letters and underlines are given mainly for convenience of descriptions in the present specification. As described later, however, it is possible to use such bold letters and underlines as decoration of sentences in a case of presenting the generation sentence GS to the user.

In the example indicated in the upper part of FIG. 9, the generation sentence GS1 includes elements GSE6 through GSE8. Here, in the example, the element GSE6 is identical with the element EM6 which is included in the prompt PR1. The element GSE8 is identical with the element EM8 which is included in the prompt PR1.

Meanwhile, the element GSE7 has been changed by the language model LM with respect to the element EM7 included in the prompt PR1. More specifically, the term of validity has been changed to “2 years” by the language model LM in accordance with the constraint condition INE1 (—the term of validity is changed to 2 years) included in the prompt PR1.

Moreover, in accordance with the constraint condition INE2 (—the term of validity can be extended upon discussion between both parties that have concluded the contract) included in the prompt PR1, a sentence “The term of validity can be extended upon discussion between both parties that have concluded the contract.” is added.

### (Step S123)

Subsequently, in step S123, the revision section 14 revises the generation sentence GS which has been acquired in step S13. For example, the revision section 14 revises the generation sentence GS with use of an industry-type-specific model specific to a work category of a target.

The lower part of FIG. 9 illustrates RGS1, which is an example of a generation sentence RGS which has been revised by the revision section 14 in this step. In the example of the lower part of FIG. 9, bold letters and underlines are given mainly for convenience of descriptions in the present specification. As described later, however, it is possible to use such bold letters and underlines as decoration of sentences in a case of presenting the generation sentence GS to the user.

In this example, the revision section 14 revises, out of the elements GSE6 through GSE8 included in the generation sentence GS1, the wording “upon discussion” included in the element GS7 to read “upon consultation”, and thus generates the revised element RGSE7.

Here, the expression “upon discussion” can be said to be an appropriate expression as long as the expression is used in a normal conversation, document, or the like. However, the expression cannot be said to be appropriate in “contract” or “work to generate or edit a contract”, which is the work category of the target in this example. In this step, revision of the generation sentence GS is carried out with use of an industry-type-specific model which has been trained specifically to the work category of the target. Therefore, as described above, it is possible to accurately carry out a delicate revision process corresponding to the work category.

### (Step S124)

In step S124, the control section 10, for example, outputs as data the revised generation sentence RGS which has been generated by the revision section 14 via the input-output section 40 or presents the revised generation sentence RGS to a user. Here, in the case of presenting the revised generation sentence RGS to a user, it is possible to present the revised part with an underline given as illustrated in the lower part of FIG. 9 so that the user can recognize the part revised by the revision section 14. Moreover, as illustrated in the lower section of FIG. 9, the changed part may be indicated by bold letters so that the user can recognize the part changed from the element included in the prompt PR1. It is possible to employ a configuration in which the control section 10 presents, to the user, both the generation sentence GS1 before revision and the revised generation sentence RGS1.

As such, the information processing apparatus 100 in accordance with the present example embodiment employs the configuration of: identifying a work category of a target; generating a prompt corresponding to the identified work category; and acquiring a generation sentence generated based on the prompt. Therefore, according to the information processing apparatus 100, it is possible to provide a work assistance technique which is applicable to various kinds of work (e.g., an assistance technique for work to generate or edit a contract).

The information processing apparatus 100 in accordance with the present example embodiment may use, in the process of extracting an element from a target sentence (step S112), the process of identifying a work category of a target (step S11), and the process of revising the generation sentence GS (step S123), an industry-type-specific model which has been trained specifically for each work. By using the industry-type-specific model, it is possible to accurately carry out these processes.

### Example 2 of Prompt Generation and Generation Sentence Output Process

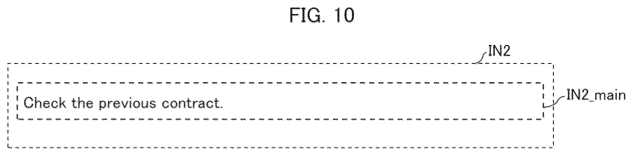

The following description will discuss example 2 of a prompt generation and generation sentence output process which is carried out by the information processing apparatus 100, with reference to FIGS. 10 through 12. The process in accordance with this example includes processes similar to those described in “Example 1 of prompt generation and generation sentence output process”. Therefore, the following description will discuss mainly a difference between the processes in accordance with this example and the above-described “Example 1 of prompt generation and generation sentence output process”.

FIG. 10 illustrates a user instruction IN2, which is an example of the user instruction acquired by the acquisition section 13 in accordance with this example in step S121 of FIG. 6 described above. As illustrated in FIG. 10, the user instruction in accordance with this example includes an instruction “check the previous contract” to check a contract of a target.

The identification section 11 in accordance with this example identifies a work category with reference to the user instruction IN2 through a process similar to that in step S11 illustrated in FIG. 6. In this example, the identification section 11 identifies, with reference to the wording “contract” and “check” included in the user instruction IN2, that the work category of the target is “work to check a contract”.

Subsequently, with a process similar to that in step S122 illustrated in FIG. 6, the generation section 12 in accordance with this example acquires one or more elements associated with the work category of the target. Here, the generation section 12 may acquire, with further reference to the user instruction IN2, one or more elements associated with the work category of the target. For example, it is possible to employ a configuration in which the generation section 12 identifies, with reference to the wording “the previous contract” included in the user instruction IN2, a contract which has been processed immediately before, and acquires one or more elements associated with the contract. Note that these elements can be extracted in advance by the process described in “Element extraction process carried out by generation section 12” above.

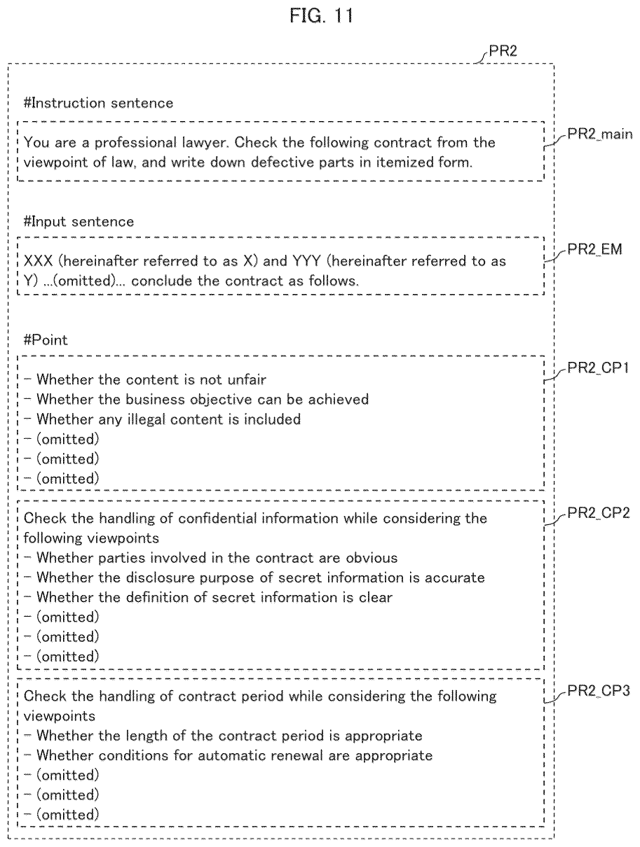

Subsequently, the generation section 12 in accordance with this example generates a prompt PR by a process similar to that in step S12 illustrated in FIG. 6. FIG. 11 illustrates a prompt PR2 which is an example of the prompt PR generated by the generation section 12 in accordance with this example with reference to the user instruction IN2.

As illustrated in FIG. 11, the prompt PR2 includes:
a tag indicating an instruction sentence (#instruction sentence);
content of an instruction sentence (PR2_main);
a tag indicating an input sentence (#input sentence);
content of an input sentence (PR2_EM);
a tag indicating a point (note in checking task) (#point); and
content of a point (note in checking task) (PR2_CP1 through PR2_CP3).

Here, the content of an instruction sentence (PR2_main) is content generated by the generation section 12 in accordance with this example in accordance with the work category which has been identified in step S11 by the identification section 11 in accordance with this example. In the example illustrated in FIG. 11, the content of an instruction sentence (PR2_main) includes an instruction sentence “You are a professional lawyer. Check the following contract from the viewpoint of law, and write down defective parts in itemized form.” which corresponds to the work category “work to check a contract” of the target.

Meanwhile, the content of an input sentence (PR2_EM) includes one or more elements which have been acquired in step S122 by the generation section 12 in accordance with this example. In the example illustrated in FIG. 11, elements which have been acquired in step S122 by the generation section 12 in accordance with this example are included as elements which are associated with “the previous contract”.

The content of a point (note in checking task) includes a plurality of matters to be noted in the work category “work to check a contract”. For example, the content of the point includes the following notes as a general note PR2_CP1:
whether the content is not unfair;
whether the business objective can be achieved;
whether any illegal content is included; and the like.

The above content of the point includes the following notes as a note PR2_CP2 pertaining to handling of confidential information:
whether parties involved in the contract are obvious;
whether the disclosure purpose of secret information is accurate;
whether the definition of secret information is clear; and the like.

The above content of the point includes the following items as a note PR2_CP3 pertaining to handling a contract period:
whether the length of the contract period is appropriate;
whether conditions for automatic renewal are appropriate; and the like.

It is possible to employ a configuration in which the generation section 12 generates a plurality of points described above in accordance with at least one of a work category of a target and a user instruction. Alternatively, it is possible to employ a configuration in which selection is made, in accordance with at least one of a work category of a target and a user instruction, from a plurality of notes which have been prepared in advance.

Alternatively, it is possible to employ a configuration in which the generation section 12 prepares, as a prompt template associated with the work category “work to check a contract”, a prompt template including:
a tag indicating an instruction sentence (#instruction sentence);
a tag indicating an input sentence (#input sentence);
a tag indicating a point (note in checking task) (#point); and
content of a point (note in checking task) (PR2_CP1 through PR2_CP3),
   and generates the prompt PR described above by applying, to the prompt template, the content of an instruction sentence (PR2_main) and the content of an input sentence (PR2_EM).

The prompt PR2 generated as described above is provided to the generation apparatus 50 by a process similar to the process described in “Example 1 of prompt generation and generation sentence output process”. The acquisition section 13 in accordance with this example acquires, in the generation apparatus 50, a generation sentence GS2 which has been generated by the language model LM based on the prompt PR2.

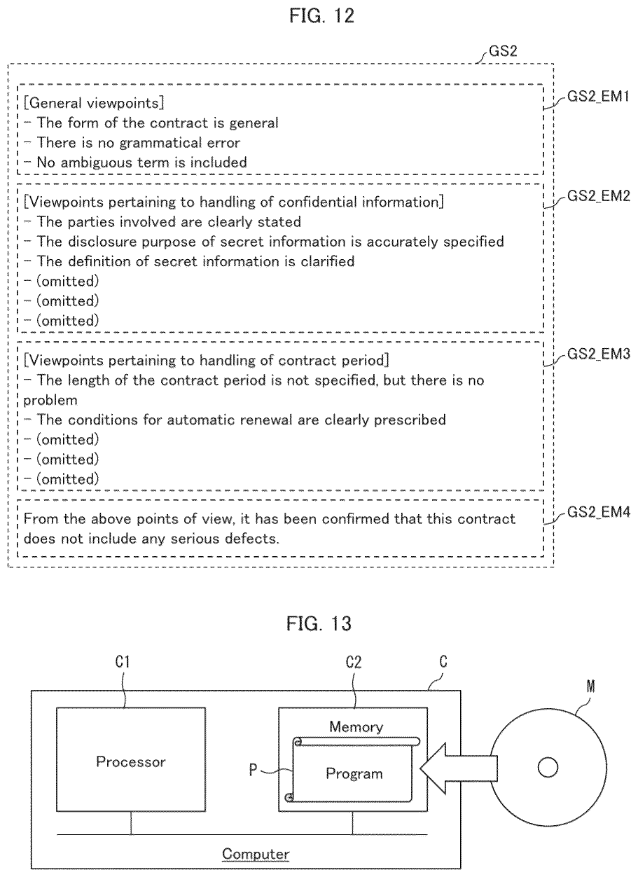

FIG. 12 is a diagram illustrating the generation sentence GS2 which has been acquired by the acquisition section 13 in accordance with this example. As illustrated in FIG. 12, the generation sentence GS2 includes checking results (GS2_EM1 through GS2_EM4) generated by the language model LM.

The checking result GS2_EM1 is a result that has been generated in accordance with the general note PR2_CP1 in the prompt PR2. For example, as illustrated in FIG. 12, the checking result GS2_EM1 includes the following checking results:
the form of the contract is general;
there is no grammatical error;
no ambiguous term is included; and the like.

The checking result GS2_EM2 is a result that has been generated in accordance with the note PR2_CP2 pertaining to handling of confidential information in the prompt PR2. For example, as illustrated in FIG. 12, the checking result GS2_EM2 includes the following checking results:
the parties involved are clearly stated;
the disclosure purpose of secret information is accurately specified;
the definition of secret information is clarified; and the like.

The checking result GS2_EM3 is a result that has been generated in accordance with the note PR2_CP3 pertaining to handling of the contract period in the prompt PR2. For example, as illustrated in FIG. 12, the checking result GS2_EM3 includes the following checking results:
the length of the contract period is not specified, but there is no problem;
the conditions for automatic renewal are clearly prescribed; and the like.

The checking result GS2_EM4 indicates a comprehensive checking result obtained from checking results according to the plurality of viewpoints above, and includes, for example, the wording “From the above points of view, it has been confirmed that this contract does not include any serious defects.” as illustrated in FIG. 12.

The generation sentence GS2 acquired by the acquisition section 13 in accordance with this example is, for example, presented to a user via the input-output section 40. As another example, it is possible to employ a configuration in which the revision section 14 in accordance with this example revises the generation sentence GS2 and presents a revised generation sentence RGS2 to the user. In such a configuration, in the revision process, an industry-type-specific model specific to a work category of a target may be used, as with “Example 1 of prompt generation and generation sentence output process”.

In this processing example also, the information processing apparatus 100 employs the configuration of: identifying a work category of a target; generating a prompt corresponding to the identified work category; and acquiring a generation sentence generated based on the prompt. Therefore, according to the information processing apparatus 100, it is possible to provide a work assistance technique which is applicable to various kinds of work (e.g., an assistance technique for work to check a contract).

The information processing apparatus 100 in accordance with the present example embodiment may use, in the process of extracting an element from a target sentence (step S112), the process of identifying a work category of a target (step S11), and the process of revising the generation sentence GS (step S123), an industry-type-specific model which has been trained specifically for each work. By using the industry-type-specific model, it is possible to accurately carry out these processes.

The above descriptions have separately described “Example 1 of prompt generation and generation sentence output process” and “Example 2 of prompt generation and generation sentence output process”. Note, however, that this does not necessarily mean that these processes are carried out separately. For example, the generation section 12 may be configured to:
generate a prompt including the prompt PR1 and the prompt PR2; and
acquire a generation sentence which has been generated based on the prompt and which includes the generation sentence GS1 based on the prompt PR1 and the generation sentence GS2 based on the prompt PR2.

### [Software Implementation Example]

Some or all of the functions of the information processing apparatus (1, 100) may be implemented by hardware such as an integrated circuit (IC chip), or may be implemented by software.

In the latter case, the information processing apparatus (1, 100) is realized by, for example, a computer that executes instructions of a program that is software realizing the foregoing functions. FIG. 13 illustrates an example of such a computer (hereinafter, referred to as “computer C”). The computer C includes at least one processor C1 and at least one memory C2. The memory C2 stores a program P for causing the computer C to function as the information processing apparatus (1, 100). The processor C1 of the computer C retrieves the program P from the memory C2 and executes the program P, so that the functions of the information processing apparatus (1, 100) are implemented.

As the processor C1, for example, it is possible to use a central processing unit (CPU), a graphic processing unit a (GPU), digital signal processor (DSP), a processing unit (MPU), a floating point number processing unit (FPU), a physics processing unit (PPU), a tensor processing unit (TPU), a quantum processor, a microcontroller, or a combination of these. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communication network, a broadcast wave, or the like. The computer C can obtain the program P also via such a transmission medium.

### [Additional Remark 1]

The present disclosure includes techniques described in supplementary notes below. Note, however, that the present invention is not limited to the techniques described in supplementary notes below, but may be altered in various ways by a skilled person within the scope of the claims.

### (Supplementary Note A1)

An information processing apparatus, including: an identification means for identifying a work category of a target; a generation means for generating a prompt that corresponds to the work category which has been identified by the identification means; and an acquisition means for acquiring a generation sentence which has been generated based on the prompt.

### (Supplementary Note A2)

The information processing apparatus according to supplementary note A1, in which: the generation means generates the prompt which includes content corresponding to an instruction from a user.

### (Supplementary Note A3)

The information processing apparatus according to supplementary note A1 or A2, in which: the work category includes work to generate or edit a contract; and the prompt includes an instruction to generate or edit a contract.

### (Supplementary Note A4)

The information processing apparatus according to any one of supplementary notes A1 through A3, in which: the work category includes work to check a contract; and the prompt includes an instruction to check a contract.

### (Supplementary Note A5)

The information processing apparatus according to any one of supplementary notes A1 through A4, further including: a revision means for revising the generation sentence in accordance with the work category which has been identified by the identification means.

### (Supplementary Note A6)

The information processing apparatus according to supplementary note A5, in which: the generation means carries out an extraction process of extracting, from one or more target sentences, one or more elements corresponding to the work category which has been identified by the identification means, and generates the prompt corresponding to the one or more elements which have been extracted in the extraction process.

### (Supplementary Note A7)

The information processing apparatus according to supplementary note A6, in which: the generation means generates the prompt which includes (i) an instruction sentence corresponding to the instruction from the user and (ii) the one or more elements which have been extracted in the extraction process.

### (Supplementary Note A8)

The information processing apparatus according to supplementary note A7, in which: the generation means carries out the extraction process with use of a language model which has been trained for each work category.

### (Supplementary Note B1)

An information processing method, comprising: identifying, by at least one processor, a work category corresponding to a target sentence; generating, by the at least one processor, a prompt corresponding to the work category y which has been identified in the identifying; and acquiring, by the at least one processor, a generation sentence which has been generated based on the prompt.

### (Supplementary Note B2)

The information processing method according to supplementary note B1, in which: in the generating, the prompt which includes content corresponding to an instruction from a user is generated.

### (Supplementary Note B3)

The information processing method according to supplementary note B1 or B2, in which: the work category includes work to generate or edit a contract; and the prompt includes an instruction to generate or edit a contract.

### (Supplementary Note B4)

The information processing method according to any one of supplementary notes B1 through B3, in which: the work category includes work to check a contract; and the prompt includes an instruction to check a contract.

### (Supplementary Note B5)

The information processing method according to any one of supplementary notes B1 through B4, further including: revising the generation sentence in accordance with the work category which has been identified in the identifying.

### (Supplementary Note B6)

The information processing method according to supplementary note B5, in which: in the generating, an extraction process of extracting, from one or more target sentences, one or more elements corresponding to the work category which has been identified in the identifying is carried out, and the prompt corresponding to the one or more elements which have been extracted in the extraction process is generated.

### (Supplementary Note B7)

The information processing method according to supplementary note B6, in which: in the generating, the prompt is generated which includes (i) an instruction sentence corresponding to the instruction from the user and (ii) the one or more elements which have been extracted in the extraction process.

### (Supplementary Note B8)

The information processing method according to supplementary note B7, in which: in the generating, the extraction process is carried out with use of a language model which has been trained for each work category.

### (Supplementary Note C1)

A program for causing a computer to carry out: an identification process of identifying a work category corresponding to a target sentence; a generation process of generating a prompt that corresponds to the work category which has been identified in the identification process; and an acquisition process of acquiring a generation sentence which has been generated based on the prompt.

### (Supplementary Note C2)

The program according to supplementary note C1, in which: in the generation process, the prompt which includes content corresponding to an instruction from a user is generated.

### (Supplementary Note C3)

The program according to supplementary note C1 or C2, in which: the work category includes work to generate or edit a contract; and the prompt includes an instruction to generate or edit a contract.

### (Supplementary Note C4)

The program according to any one of supplementary notes C1 through C3, in which: the work category includes work to check a contract; and the prompt includes an instruction to check a contract.

### (Supplementary Note C5)

The program according to any one of supplementary notes C1 through C4, further including: a revision process of revising the generation sentence in accordance with the work category which has been identified in the identification process.

### (Supplementary Note C6)

The program according to supplementary note C5, in which: in the generation process, an extraction process of extracting, from one or more target sentences, one or more elements corresponding to the work category which has been identified in the identification process is carried out, and the prompt corresponding to the one or more elements which have been extracted in the extraction process is generated.

### (Supplementary Note C7)

The program according to supplementary note C6, in which: in the generation process, the prompt is generated which includes (i) an instruction sentence corresponding to the instruction from the user and (ii) the one or more elements which have been extracted in the extraction process.

### (Supplementary Note C8)

The program according to supplementary note C7, in which: in the generation process, the extraction process is carried out with use of a language model which has been trained for each work category.

### [Additional Remark 2]

The present disclosure includes techniques described in supplementary notes below. Note, however, that the present invention is not limited to the techniques described in supplementary notes below, but may be altered in various ways by a skilled person within the scope of the claims.

### (Supplementary Note D1)

An information processing apparatus, including at least one processor, the at least one processor carrying out: an identification process of identifying a work category corresponding to a target sentence; a generation process of generating a prompt that corresponds to the work category which has been identified in the identification process; and an acquisition process of acquiring a generation sentence which has been generated based on the prompt.

Note that the information processing apparatus can further include a memory. The memory may store a program for causing the at least one processor to carry out the foregoing processes.

### (Supplementary Note D2)

The information processing apparatus according to supplementary note D1, in which: in the generation process, the prompt which includes content corresponding to an instruction from a user is generated.

### (Supplementary Note D3)

The information processing apparatus according to supplementary note D1 or D2, in which: the work category includes work to generate or edit a contract; and the prompt includes an instruction to generate or edit a contract.

### (Supplementary Note D4)

The information processing apparatus according to any one of supplementary notes D1 through D3, in which: the work category includes work to check a contract; and the prompt includes an instruction to check a contract.

### (Supplementary Note D5)

The information processing apparatus according to any one of supplementary notes D1 through D4, in which: the at least one processor further carries out a revision process of revising the generation sentence in accordance with the work category which has been identified in the identification process.

### (Supplementary Note D6)

The information processing apparatus according to supplementary note D5, in which: in the generation process, an extraction process of extracting, from one or more target sentences, one or more elements corresponding to the work category which has been identified in the identification process is carried out, and the prompt corresponding to the one or more elements which have been extracted in the extraction process is generated.

### (Supplementary Note D7)

The information processing apparatus according to supplementary note D6, in which: in the generation process, the prompt is generated which includes (i) an instruction sentence corresponding to the instruction from the user and (ii) the one or more elements which have been extracted in the extraction process.

### (Supplementary Note D8)

The information processing apparatus according to supplementary note D7, in which: in the generation process, the extraction process is carried out with use of a language model which has been trained for each work category.

### REFERENCE SIGNS LIST

1, 100: Information processing apparatus
11: Identification section
12: Generation section
13: Acquisition section
14: Revision section

1. An information processing apparatus, comprising at least one processor, the at least one processor carrying out:
an identification process of identifying a work category of a target;
a generation process of generating a prompt that corresponds to the work category which has been identified in the identification process; and
an acquisition process of acquiring a generation sentence which has been generated based on the prompt.

2. The information processing apparatus according to claim 1, wherein:
in the generation process, the at least one processor generates the prompt which includes content corresponding to an instruction from a user.

3. The information processing apparatus according to claim 2, wherein:
the work category includes work to generate or edit a contract; and
the prompt includes an instruction to generate or edit a contract.

4. The information processing apparatus according to claim 2, wherein:
the work category includes work to check a contract; and
the prompt includes an instruction to check a contract.

5. The information processing apparatus according to claim 2, wherein:
the at least one processor further carries out a revision process of revising the generation sentence in accordance with the work category which has been identified in the identification process.

6. The information processing apparatus according to claim 5, wherein:
in the generation process, the at least one processor carries out an extraction process of extracting, from one or more target sentences, one or more elements corresponding to the work category which has been identified in the identification process, and the at least one processor generates the prompt corresponding to the one or more elements which have been extracted in the extraction process.

7. The information processing apparatus according to claim 6, wherein:
in the generation process, the at least one processor generates the prompt which includes (i) an instruction sentence corresponding to the instruction from the user and (ii) the one or more elements which have been extracted in the extraction process.

8. The information processing apparatus according to claim 7, wherein:
in the generation process, the at least one processor carries out the extraction process with use of a language model which has been trained for each work category.

9. An information processing method, comprising:
identifying, by at least one processor, a work category corresponding to a target sentence;
generating, by the at least one processor, a prompt corresponding to the work category which has been identified in the identifying; and
acquiring, by the at least one processor, a generation sentence which has been generated based on the prompt.

10. A non-transitory storage medium storing a program which causes a computer to carry out:
an identification process of identifying a work category corresponding to a target sentence;
a generation process of generating a prompt that corresponds to the work category which has been identified in the identification process; and
an acquisition process of acquiring a generation sentence which has been generated based on the prompt.
